(19) United States
(12) Patent Application Publication
(10) Pub. No.: US 2010/0310981 A1
(43) Pub. Date: Dec. 9, 2010

(54) DEVELOPING AGENT AND METHOD FOR PRODUCING THE SAME

(75) Inventors: Junichi Ishikawa, Shizuoka-ken (JP); Takayasu Aoki, Shizuoka-ken (JP); Tsuyoshi Itou, Shizuoka-ken (JP); Yasuhito Noda, Shizuoka-ken (JP); Motonari Udo, Shizuoka-ken (JP); Satoshi Araki, Shizuoka-ken (JP); Masahiro Ikuta, Shizuoka-ken (JP); Takafumi Hara, Shizuoka-ken (JP); Takashi Urabe, Shizuoka-ken (JP); Taishi Takano, Shizuoka-ken (JP); Yasuo Goto, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/792,132

(22) Filed: Jun. 2, 2010

Related U.S. Application Data
(60) Provisional application No. 61/184,117, filed on Jun. 4, 2009.

(51) Int. Cl. G03G 9/087; G03G 9/08

(52) U.S. Cl. 430/109.4; 430/137.14; 430/110.1

(57) ABSTRACT

According to one embodiment, a method for producing a developing agent includes pulverizing a mixture in the form of coarse particles of a toner material including a coloring agent and a binder resin by mechanical shearing, aggregating and fusing the resulting fine particles. The solid content concentration in a dispersion liquid including the aggregated particles is from 5.0% to 40.0%, the volume average particle diameter of the aggregated particles is from 1.0 μm to 10.0 μm, and the ratio of the standard deviation to the volume average particle diameter is 30.0% or less.

### CROSS-REFERENCE TO RELATED APPLICATIONS

This application is based upon and claims the benefit of priority from U.S. Provisional Application No. 61/184,117, filed on Jun. 4, 2009, the entire contents of which are incorporated herein by reference.

### FIELD

Embodiments described herein relate generally to a developing agent to be used for developing an electrostatic image or a magnetic latent image in an electrophotographic process, an electrostatic printing process, a magnetic recording process, or the like; and a method for producing the same.

### BACKGROUND

In an electrophotographic process, an electric latent image is formed on an image carrying member, subsequently the latent image is developed with a toner, and the resulting toner image is transferred onto a transfer material such as paper and fixed thereon by heating, applying pressure or the like. As the toner to be used, not only a conventional single black color toner, but also toners of a plurality of colors are used for forming a full color image, and an image is formed.

As the toner, a two-component developing agent to be used by mixing with carrier particles and a one-component developing agent to be used as a magnetic toner or a non-magnetic toner are known. As for a method for producing such a toner, the toner is generally produced by a kneading pulverization method. This kneading pulverization method is a method for producing desired toner particles by melt-kneading a binder resin, a pigment, a release agent such as a wax, a charge control agent, and the like, cooling the resulting mixture, followed by finely pulverizing the cooled mixture, and then classifying the finely pulverized mixture. Inorganic and/or organic fine particles are added to the surfaces of toner particles produced by the kneading pulverization method in accordance with the intended use, and thus, a toner can be obtained.

In the case of toner particles produced by the kneading pulverization method, their shape is usually amorphous and their surface composition is not uniform. Although the shape and the surface composition of toner particles are subtly changed depending on the pulverizability of the material to be used and conditions for the pulverization step, it is difficult to intentionally control the shape.

Further, particularly when a material with a high pulverizability was used, the particles were more finely pulverized or their shape was changed due to various stresses in a developing machine. As a result, in a two-component developing agent, a problem arose that the finely pulverized toner adhered to a carrier surface, thereby accelerating deterioration of chargeability of the developing agent. Also, in a one-component developing agent, a problem arose that the particle size distribution increased, and therefore the finely pulverized toner was scattered, or the developability was deteriorated due to a change in the toner shape, and therefore, an image quality was deteriorated.

Further, when the toner contains a release agent such as a wax, the release agent may sometimes be exposed on the surface of the toner because pulverization is likely to be caused at an interface between the binder resin and the release agent. In particular, when the toner is formed from a resin which has a high elasticity and is difficult to pulverize and a brittle wax such as polyethylene, exposure of polyethylene on the surface of the toner is much seen. Although such a toner is advantageous in terms of a release property at the time of fixing and cleaning of untransferred toner on a photoconductor, the polyethylene on the surface of the toner is detached from the toner by a mechanical force such as a shearing force in the developing machine and can be easily transferred to a developing roller, an image carrying member, a carrier, or the like. Therefore, contamination of the developing roller, image carrying member, carrier or the like with the wax was easily caused, and the reliability as a developing agent was lowered in some cases.

Under such circumstances, recently, as a method for producing a toner in which the shape and surface composition of toner particles are intentionally controlled, an emulsion polymerization aggregation method is proposed.

The emulsion polymerization aggregation method is a method for obtaining toner particles by separately preparing a resin dispersion liquid by emulsion polymerization and a coloring agent dispersion liquid in which a coloring agent is dispersed in a solvent, mixing these dispersion liquids to form aggregated particles with a size corresponding to a toner particle size, and fusing the aggregated particles by heating. According to this emulsion polymerization aggregation method, the toner shape can be arbitrarily controlled from amorphous to spherical shape by selecting a heating temperature condition.

In the emulsion polymerization aggregation method, a toner can be obtained by subjecting at least a dispersion liquid of resin fine particles and a dispersion liquid of a coloring agent to aggregation and fusion under a predetermined condition. However, the emulsion polymerization aggregation method is limited as to the type of resin which can be synthesized, and a polyester resin which is known to have a good fixability cannot be used in the method, though the method is suitable for the production of a styrene-acrylic copolymer.

On the other hand, as a method for producing a toner using a polyester resin, a phase inversion emulsification method in which a pigment dispersion liquid and the like are added to a solution obtained by dissolving a polyester resin in an organic solvent and then water is added thereto is known, however, it is necessary to remove and recover the organic solvent. A method for producing fine particles by mechanical shearing in an aqueous medium without using an organic solvent is proposed. However, it was necessary to feed a resin or the like in a molten state to a stirring device, and handling thereof was difficult. Further, the degree of freedom for shape control was low, and the shape of a toner could not be arbitrarily controlled from amorphous to spherical shape.

### BRIEF DESCRIPTION OF THE DRAWINGS

FIG. 1 is a flow diagram showing a method for producing a developing agent according to an embodiment.

FIG. 2 is a view showing a structure of a high-pressure pulverizer which can be used in an embodiment.

FIG. 3 is a view showing a structure of an image forming apparatus which can use a developing agent according to an embodiment.

### DETAILED DESCRIPTION

In general, according to one embodiment, a method for producing a developing agent includes first mixing a granular mixture containing a binder resin and a coloring agent with an aqueous medium, thereby forming an aqueous dispersion liquid. Subsequently, the resulting dispersion liquid is subjected to mechanical shearing to pulverize the mixture in the dispersion liquid, thereby forming fine particles having a volume average particle diameter smaller than that of the mixture. Thereafter, the fine particles are aggregated in the dispersion liquid to form aggregated particles, followed by fusing the aggregated particles, thereby forming toner particles. In this embodiment, the binder resin to be used has an acid value of from 1 to 13. Further, the solid content concentration of in the dispersion liquid containing the aggregated particles is adjusted to 5.0% to 40.0%. Further, the aggregated particles have a volume average particle diameter of from 1.0 μm to 10.0 μm, and a ratio of the standard deviation to the volume average particle diameter of 30.0% or less.

According to another embodiment, a developing agent contains toner particles which are produced by a method including mixing a granular mixture containing a binder resin and a coloring agent with an aqueous medium, thereby forming an aqueous dispersion liquid; subjecting the formed dispersion liquid to mechanical shearing to pulverize the mixture in the dispersion liquid, thereby forming fine particles having a volume average particle diameter smaller than that of the mixture; and aggregating the fine particles in the dispersion liquid to form aggregated particles, followed by fusing the aggregated particles. In this embodiment, the binder resin has an acid value of from 1 to 13, the dispersion liquid containing the aggregated particles has a solid content concentration of from 5.0% to 40.0%, and the aggregated particles have a volume average particle diameter of from 1.0 μm to 10.0 μm, and a ratio of the standard deviation to the volume average particle diameter of 30.0% or less.

According to the embodiment, using a method of aggregating a polyester resin having a low acid value in an aqueous medium, a favorable electrophotographic toner having a uniform particle size distribution can be produced with reduced resources.

Hereinafter, the embodiment will be described in more detail with reference to the drawings.

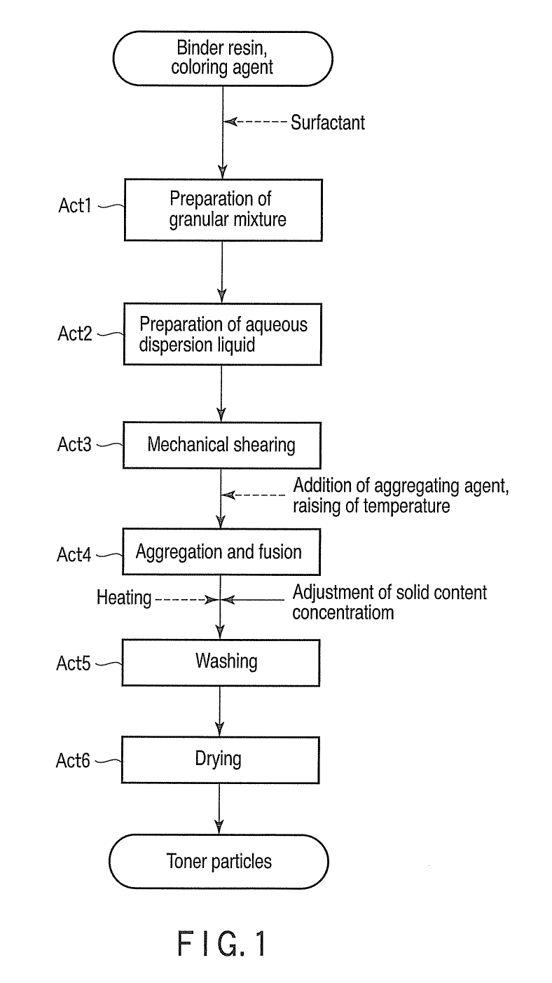

FIG. 1 is a flow diagram showing a method for producing a developing agent according to one embodiment.

First, a mixture in the form of coarse particles containing at least a binder resin and a coloring agent is prepared (Act 1). The mixture in the form of coarse particles can have a volume average particle diameter of from 0.015 mm to 0.1 mm. The mixture in the form of coarse particles can be obtained by, for example, melt-kneading a binder resin and a coloring agent, followed by grinding. As the binder resin, for example, a polyester resin or the like can be used.

Subsequently, an aqueous medium such as water is mixed with the mixture in the form of coarse particles, thereby forming an aqueous dispersion liquid (Act 2).

In the step of forming the dispersion liquid of the mixture in the form of coarse particles, at least one of a surfactant and a pH adjusting agent can be optionally added to the aqueous medium.

By the addition of a surfactant, the mixture in the form of coarse particles can be easily dispersed in the aqueous medium due to the action of the surfactant adsorbed on the surface of the mixture. Further, by the addition of a pH adjusting agent, the degree of dissociation of a dissociable functional group on the surface of the mixture is increased or the polarity thereof is increased, and therefore, the self-dispersibility can be improved. The aqueous dispersion liquid preferably has an alkaline pH.

Subsequently, the resulting dispersion liquid is heated to a desired temperature. It is necessary to raise the temperature of the dispersion liquid to a temperature not lower than the glass transition temperature of the polyester resin to be used so as to effect pulverization. Further, a higher temperature is advantageous because pulverization of colored particles is facilitated at a high temperature, however, hydrolysis is accelerated to cause deterioration of fixability or the like. The dispersion liquid heated to a desired temperature is subjected to mechanical shearing to finely pulverize the mixture in the form of coarse particles, thereby preparing a dispersion liquid containing fine particles (Act 3).

The fine particles can have a volume average particle diameter of preferably 1.0 μm or less, more preferably 0.5 μm or less.

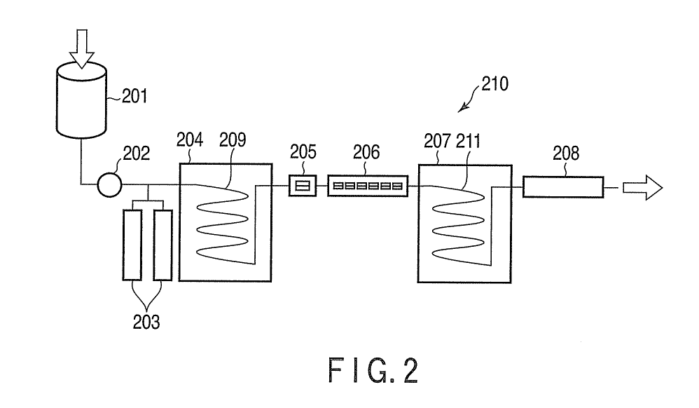

FIG. 2 is a view showing a structure of a high-pressure pulverizer.

The high-pressure pulverizer is a device configured to apply a shearing force by allowing a material to pass through a fine nozzle while applying a pressure of from 10 MPa to 300 MPa by means of a high-pressure pump to pulverize the material into fine particles.

As shown in FIG. 2, a high-pressure homogenizer 210 which is one example of the high-pressure wet-type pulverizer has a structure in which a hopper tank 201, a liquid feed pump 202, a high-pressure pump 203, a heating unit 204, a pulverizing unit 205, a pressure reducing unit 206, a cooling unit 207, and a pressure reducing unit 208 are arranged in this order, and includes pipes which connect the respective units.

The hopper tank 201 is a tank to which a process liquid is fed. While the device is being operated, it is necessary to always fill the tank with a liquid so as not to send air to the device. When the particles in the process liquid have a large particle diameter and are likely to precipitate, a stirrer can be further installed in the tank.

The liquid feed pump 202 is installed for continuously feeding the process liquid to the high-pressure pump 203. Further, this liquid feed pump 202 is also effective in avoiding clogging of a check valve (not shown) installed in the high-pressure pump 203. As the pump 202, for example, a diaphragm pump, a tubing pump, a gear pump, or the like can be used.

The high-pressure pump 203 is a plunger pump and has check valves at a process liquid inlet port (not shown) and a process liquid outlet port (not shown). The number of plungers varies depending on the production scale, and one to ten plungers are used. In order to reduce a pulsating current as much as possible, it is preferred that two or more plungers are used.

The heating unit 204 is provided with a high-pressure pipe 209 formed into a spiral shape so as to have a large heat exchange area in a heating device such as an oil bath. It does not matter whether this heating unit 204 is installed on the upstream side or downstream side of the high-pressure pump 203 in the flow direction of the dispersion liquid, however, it is necessary to install this heating unit 204 at least on the upstream side of the pulverizing unit 205. When the heating unit 204 is installed on the upstream side of the high-pressure pump 203, a heating device may be installed in the hopper tank 201, however, the time for which the process liquid is retained at a high temperature is long, and therefore, thermal decomposition is liable to occur.

The pulverizing unit 205 includes a nozzle having a small diameter for applying a strong shearing force. The diameter and shape of the nozzle vary, however, the diameter thereof is preferably from 0.05 mm to 0.5 mm, and as for the shape thereof, a pass-through type nozzle or a collision type nozzle is preferred. Further, this nozzle may be configured in a multiple stage structure. When a multiple stage structure is employed, a plurality of nozzles having different diameters may be arranged. As for the configuration of the arrangement of such nozzles, either parallel or series configuration may be employed. As the material of the nozzle, diamond or the like which can withstand a high pressure is used.

The cooling unit 207 is provided with a pipe 211 formed in a spiral shape so as to have a large heat exchange area in a bath in which cold water is allowed to continuously flow.

According to need, pressure reducing units 206 and 208 can be installed in the upstream and downstream of the cooling unit 207. The pressure reducing units 206 and 208 have a structure in which one or more cells or two-way valves having a flow path that is larger than the diameter of the nozzle of the pulverizing unit 205 and smaller than the diameter of the pipe connected thereto are arranged.

A treatment using this high-pressure pulverizer is performed as follows.

First, the process liquid is heated to a temperature not lower than the glass transition temperature of the binder resin used. The reason why the liquid is heated is to melt the binder resin used.

This heating temperature varies depending on the glass transition temperature of the binder resin. Further, in the case of using a method of heating the dispersion liquid by continuously passing it through the heat exchanger, the heating temperature is also affected by the flow rate of the dispersion liquid and the length of the pipe in the heat exchanger. When the flow rate is high or the length of the pipe is small, the heating temperature should be set to a high temperature, meanwhile, when the flow rate is low or the length of the pipe is large, the dispersion liquid is sufficiently heated, therefore, it is possible to perform the treatment at a low temperature. For example, when the flow rate is from 300 to 400 cc/min, the heat exchange pipe is a high-pressure pipe having a diameter of ⅜ inch and a length of 12 m, and the glass transition temperature of the binder resin is 60° C., the heating temperature can be set to, for example, 180° C.

Then, the dispersion liquid thus heated is subjected to a shearing force while applying a pressure of 10 MPa or more. At this time, it is the nozzle that applies the shearing force. By allowing the dispersion liquid to pass through the nozzle while applying a high pressure of 10 MPa or more, the molten binder resin is pulverized into fine particles. The pressure at this time is preferably from 10 MPa to 300 MPa.

Finally, the dispersion liquid is cooled to a temperature not higher than the Tg of the resin. By this cooling, the molten fine particles are solidified. Since the process liquid is rapidly cooled, aggregation or coalescence due to cooling is difficult to occur.

According to need, a back-pressure may be applied to the upstream or downstream of the cooling unit or a pressure may be reduced. The back-pressure application or pressure reduction is performed for returning the pressure of the process liquid after passing through the nozzle to close to atmospheric pressure in a single step (by back-pressure application) or in multiple steps (by pressure reduction) so as not to release the process liquid to atmospheric pressure immediately after passing through the nozzle. The pressure after passing through a back-pressure applying unit or a pressure reducing unit is from 0.1 MPa to 10 MPa, preferably from 0.1 MPa to 5 MPa. It is more preferred that in this pressure reducing unit, a plurality of cells or valves with different diameters are arranged. By reducing the pressure in multiple steps, few coarse particles are generated and fine particles having a sharp particle size distribution can be obtained.

From the thus obtained fine particles, the dispersion medium can be removed by suction filtration as needed.

Then, the dispersion liquid is cooled to the glass transition temperature of the polyester resin or lower.

From the cooled dispersion liquid, colored particles are separated, washed, and dried, and thereafter, the resulting dried fine particles can be used as a toner as such, or the resulting dried fine particles are aggregated to a desired size to form aggregated particles.

In the step of forming aggregated particles, a plurality of fine particles can be aggregated using at least one process selected from pH adjustment, addition of a surfactant, addition of a water-soluble metal salt, addition of an organic solvent, and temperature adjustment (Act 4). By adjusting these processes, the shape of the resulting aggregated particles can be controlled. Further, in order to fuse the aggregated particles to effect stabilization, the dispersion liquid can be, for example, heated to a temperature higher than the glass transition temperature of the binder resin by about 5 to 80° C.

The aggregated particles or stabilized aggregated particles preferably have a volume average particle diameter of from 1.0 to 10.0 μm.

The aggregated particles or stabilized aggregated particles preferably have a circularity of from 0.8 to 1.0. The aggregated particles or the aggregated particles stabilized by fusion preferably have a solid content concentration of from 5.0 to 40.0%, preferably from 10.0 to 35.0%. For example, in the aggregation and fusion step, after the aggregated particles are fused, the solid content concentration in the dispersion liquid can be adjusted to 5.0% to 40.0%.

The aggregated particles or stabilized aggregated particles have a ratio of the standard deviation to the volume average particle diameter of 30.0% or less.

After the aggregated particles are formed, the dispersion liquid is cooled to, for example 5° C. or the glass transition temperature or lower. Thereafter, the aggregated particles are washed using, for example, a filter press or the like (Act 5), and then dried (Act 6), whereby toner particles are obtained.

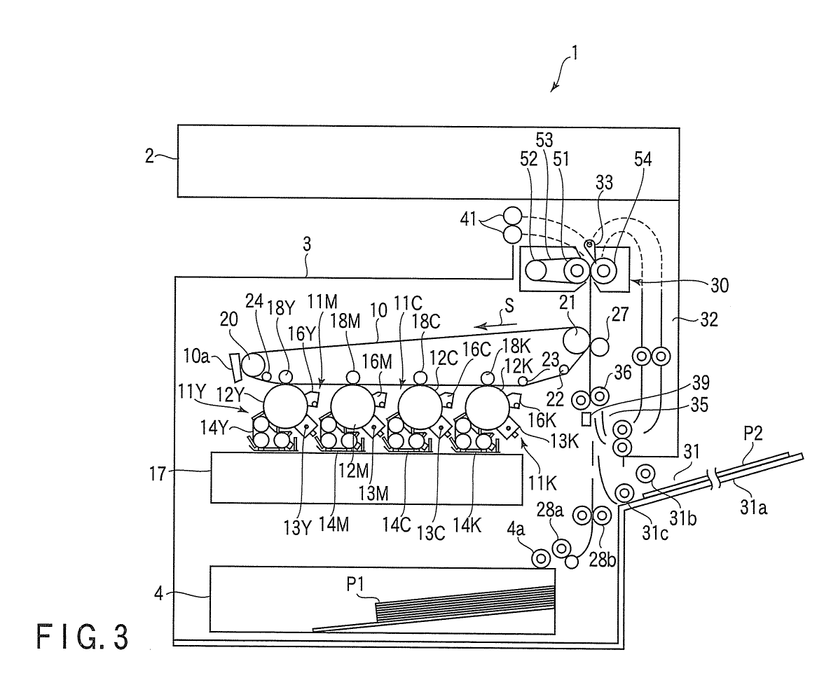

FIG. 3 is a schematic view showing a structure of a copier to which a developing agent obtained according to one embodiment can be applied.

As shown in FIG. 3, a four-drum tandem type color copier MFP (e-studio 4520c) 1 is provided with a scanner unit 2 and a paper discharge unit 3 in the upper part.

The color copier 1 has four sets of image forming stations 11Y, 11M, 11C, and 11K of yellow (Y), magenta (M), cyan (C), and black (K) arranged in parallel along the lower side of an intermediate transfer belt (intermediate transfer medium) 10.

The image forming stations 11Y, 11M, 11C, and 11K have photoconductive drums (image carrying members) 12Y, 12M, 12C, and 12K, respectively. Around the photoconductive drums 12Y, 12M, 12C, and 12K, electric chargers 13Y, 13M, 13C, and 13K, developing devices 14Y, 14M, 14C, and 14K, and photoconductor cleaning devices 16Y, 16M, 16C, and 16K are provided along the rotational direction of the arrow m, respectively. An exposure light from a laser exposure device (latent image forming device) 17 is applied to areas between the respective electric chargers 13Y, 13M, 13C, and 13K and the respective developing devices 14Y, 14M, 14C, and 14K around the photoconductive drums 12Y, 12M, 12C, and 12K, and electrostatic latent images are formed on the photoconductive drums 12Y, 12M, 12C, and 12K, respectively.

The developing devices 14Y, 14M, 14C, and 14K each have a two-component developing agent containing a toner of yellow (Y), magenta (M), cyan (C), or black (K) and a carrier and supply the toner to the electrostatic latent images on the photoconductive drums 12Y, 12M, 12C, and 12K, respectively.

The intermediate transfer belt 10 is tensioned by a backup roller 21, a driven roller 20, and first to third tension rollers 22 to 24. The intermediate transfer belt 10 faces and is in contact with the photoconductive drums 12Y, 12M, 12C, and 12K. At the positions of the intermediate transfer belt 10 facing the photoconductive drums 12Y, 12M, 12C, and 12K, primary transfer rollers 18Y, 18M, 18C, and 18K for primarily transferring toner images on the photoconductive drums 12Y, 12M, 12C, and 12K onto the intermediate transfer belt 10 are provided. The primary transfer rollers 18Y, 18M, 18C, and 18K are each a conductive roller, and apply a primary transfer bias voltage to the respective primary transfer parts.

In a secondary transfer part which is a transfer position supported by the backup roller 21 of the intermediate transfer belt 10, a secondary transfer roller 27 is provided. In the secondary transfer part, the backup roller 21 is a conductive roller and a predetermined secondary transfer bias is applied thereto. When a sheet of paper (final transfer medium) which is a print target passes between the intermediate transfer belt 10 and the second transfer roller 27, the toner image on the intermediate transfer belt 10 is secondarily transferred onto the sheet of paper. After completion of the secondary transfer, the intermediate transfer belt 10 is cleaned by a belt cleaner 10a.

A paper feed cassette 4 for feeding a sheet of paper in the direction toward the secondary transfer roller 27 is provided below the laser exposure device 17. On the right side of the color copier 1, a manual feed mechanism 31 for manually feeding a sheet of paper is provided.

A pickup roller 4a, a separating roller 28a, a conveying roller 28b, and a resist roller pair 36 are provided between the paper feed cassette 4 and the secondary transfer roller 27, and these are constituent members of a paper feed mechanism. A manual feed pickup roller 31b and a manual feed separating roller 31c are provided between a manual feed tray 31a of the manual feed mechanism 31 and the resist roller pair 36.

Further, a medium sensor 39 for detecting the kind of sheet of paper is disposed on a vertical conveying path 34 for conveying a sheet of paper in the direction from the paper feed cassette 4 or the manual feed tray 31a to the secondary transfer roller 27. In the color copier 1, the conveying speed of a sheet of paper, a transfer condition, a fixing condition, and the like can be controlled according to the detection result of the medium sensor 39. Further, a fixing device 30 is provided in the downstream of the secondary transfer part along the direction of the vertical conveying path 34.

The sheet of paper taken out from the paper feed cassette 4 or fed from the manual feed mechanism 31 is conveyed to the fixing device 30 along the vertical conveying path 34 through the resist roller pair 36 and the secondary transfer roller 27. The fixing device 30 has a set of a heating roller 51 and a driving roller 52, a fixing belt 53 wound around the heating roller 51 and the driving roller 52, and a facing roller 54 disposed to face the heating roller 51 via the fixing belt 53. The sheet of paper having the toner image transferred in the second transfer part is guided between the fixing belt 53 and the facing roller 54 and heated by the heating roller 51, whereby the toner image transferred onto the sheet of paper is fixed through the heat treatment. A gate 33 is provided in the downstream of the fixing device 30 and distributes the sheet of paper in the direction toward a paper discharge roller 41 or the direction toward a re-conveying unit 32. The sheet of paper guided to the paper discharge roller 41 is discharged to the paper discharge unit 3. Further, the sheet of paper guided to the re-conveying unit 32 is again guided in the direction toward the secondary transfer roller 27.

The image forming station 11Y integrally includes the photoconductive drum 12Y and a process tool, and is provided such that it is attachable to and detachable from the image forming apparatus main body. The process tool refers to at least one of the electric charger 13Y, the developing device 14Y, and the photoconductor cleaning device 16Y. The image forming stations 11M, 11C, and 11K each have the same structure as the image forming station 11Y, and each of the image forming stations 11Y, 11M, 11C, and 11K may be separately attachable to and detachable from the image forming apparatus, or they may be integrally attachable to and detachable from the image forming apparatus as an integral image forming unit 11.

Examples of the binder resin to be used in the embodiment include styrene resins such as polystyrene, styrene/butadiene copolymers, and styrene/acrylic copolymers; ethylene resins such as polyethylene, polyethylene/vinyl acetate copolymers, polyethylene/norbornene copolymers, and polyethylene/vinyl alcohol copolymers; polyester resins, acrylic resins, phenol resins, epoxy resins, allyl phthalate resins, polyamide resins, and maleic resins. These resins may be used alone or in combination of two or more kinds thereof.

Further, in the embodiment, at least one or more kinds of binder resins having an acid value of from 1 to 13 are contained.

As the coloring agent to be used in the embodiment, a carbon black, an organic or inorganic pigment or dye, or the like can be exemplified. For example, examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Further, examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238, C.I. Pigment Violet 19, and C.I. Vat Red 1, 2, 10, 13, 15, 23, 29, and 35. These can be used alone or in admixture. Further, examples of a cyan pigment include C.I. Pigment Blue 2, 3, 15, 16, and 17, C.I. Vat Blue 6, and C.I. Acid Blue 45. These can be used alone or in admixture.

To the mixture in the form of coarse particles, at least one of a wax and a charge control agent can be added.

Examples of the wax include aliphatic hydrocarbon waxes such as low molecular weight polyethylene, low molecular weight polypropylene, polyolefin copolymers, polyolefin waxes, microcrystalline waxes, paraffin waxes, and Fischer-Tropsch waxes; oxides of an aliphatic hydrocarbon wax such as polyethylene oxide waxes or block copolymers thereof; vegetable waxes such as candelilla wax, carnauba wax, Japan wax, jojoba wax, and rice wax; animal waxes such as bees wax, lanolin, and whale wax; mineral waxes such as ozokerite, ceresin, and petrolatum; waxes containing, as a main component, a fatty acid ester such as montanic acid ester wax and castor wax; and materials obtained by deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebisstearic acid amide, ethylenebiscaprylic acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylsebaccic acid amide; aromatic bisamides such as m-xylenebisstearic acid amide and N,N′-distearylisophthalic acid amide; fatty acid metal salts (generally called metallic soaps) such as calcium stearate, calcium laurate, zinc stearate, and magnesium stearate; waxes obtained by grafting of a vinyl monomer such as styrene or acrylic acid on an aliphatic hydrocarbon wax; partially esterified products of a fatty acid and a polyhydric alcohol such as behenic acid monoglyceride; and methyl ester compounds having a hydroxyl group obtained by hydrogenation of a vegetable fat or oil can be exemplified.

Further, as the charge control agent for controlling a frictional charge quantity, for example, a metal-containing azo compound is used, and a complex or a complex salt in which the metal element is iron, cobalt, or chromium, or a mixture thereof is preferred. Further, a metal-containing salicylic acid derivative compound can also be used, and a complex or a complex salt in which the metal element is zirconium, zinc, chromium, or boron, or a mixture thereof is preferred.

The pH adjusting agent which can be used in the embodiment is not particularly limited, however, for example, an amine compound can be used other than sodium hydroxide, potassium hydroxide, or the like.

Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane.

Examples of the surfactant which can be used in the embodiment include anionic surfactants such as sulfate-based, sulfonate-based, phosphate-based, and soap-based anionic surfactants, cationic surfactants such as amine salt-type and quaternary ammonium salt-type cationic surfactants, and nonionic surfactants such as polyethylene glycol-based, alkyl phenol ethylene oxide adduct-based, and polyhydric alcohol-based nonionic surfactants.

Examples of the mechanical shearing device which is used in the embodiment include mechanical shearing devices which do not use a medium such as Ultra Turrax (manufactured by IKA Japan K.K.), T.K. Auto Homo Mixer (manufactured by PRIMIX Corporation), T.K. Pipeline Homo Mixer (manufactured by PRIMIX Corporation), T.K. Filmics (manufactured by PRIMIX Corporation), Clear Mix (manufactured by M TECHNIQUE Co., Ltd.), Clear SS5 (manufactured by M TECHNIQUE Co., Ltd.), Cavitron (manufactured by EUROTEC, Ltd.), Fine Flow Mill (manufactured by Pacific Machinery & Engineering Co., Ltd.), Microfluidizer (manufactured by Mizuho Industry Co., Ltd.), Ultimizer (manufactured by Sugino Machine Limited), Nanomizer (manufactured by Yoshida Kogyo Co. Ltd.), Genus PY (manufactured by Hakusui Chemical Industries Co., Ltd.), and NANO 3000 (manufactured by Beryu Co., Ltd.); and mechanical shearing devices which use a medium such as Visco Mill (manufactured by Aimex Co., Ltd.), Apex Mill (manufactured by Kotobuki Industries Co., Ltd.), Star Mill (manufactured by Ashizawa Finetech Co., Ltd.), DCP Superflow (manufactured by Nippon Eirich Co., Ltd.), MP Mill (manufactured by Inoue Manufacturing Co., Ltd.), Spike Mill (manufactured by Inoue Manufacturing Co., Ltd.), Mighty Mill (manufactured by Inoue Manufacturing Co., Ltd.), and SC Mill (manufactured by Mitsui Mining Co., Ltd.).

In the embodiment, a mixed material or a kneaded material containing at least a binder resin and a coloring agent is finely pulverized while heating using a mechanical shearing device, and the material thus finely pulverized is cooled to a temperature not higher than the glass transition temperature of the resin. However, the material may be cooled to a desired temperature at which aggregation is carried out.

In the embodiment, in order to prepare the mixture in the form of coarse particles, a mixture containing at least a binder resin and a coloring agent can be kneaded.

A kneader to be used is not particularly limited as long as it can perform melt-kneading, however, examples thereof include a single-screw extruder, a twin-screw extruder, a pressure kneader, a Banbury mixer, and a Brabender mixer. Specific examples thereof include FCM (manufactured by Kobe Steel, Ltd.), NCM (manufactured by Kobe Steel, Ltd.), LCM (manufactured by Kobe Steel, Ltd.), ACM (manufactured by Kobe Steel, Ltd.), KTX (manufactured by Kobe Steel, Ltd.), GT (manufactured by Ikegai, Ltd.), PCM (manufactured by Ikegai, Ltd.), TEX (manufactured by the Japan Steel Works, Ltd.), TEM (manufactured by Toshiba Machine Co., Ltd.), ZSK (manufactured by Warner K.K.), and Kneadex (manufactured by Mitsui Mining Co., Ltd.).

In the embodiment, when the fine particles are aggregated, a water-soluble metal salt can be used. Examples of the water-soluble metal salt include metal salts such as sodium chloride, calcium chloride, calcium nitrate, barium chloride, magnesium chloride, zinc chloride, magnesium sulfate, aluminum chloride, and aluminum sulfate; and inorganic metal salt polymers such as poly(aluminum chloride), poly(aluminum hydroxide), and calcium polysulfide.

In the embodiment, when the fine particles are aggregated, an organic solvent may be used. Examples of the organic solvent include alcohols such as methanol, ethanol, 1-propanol, 2-propanol, 2-methyl-2-propanol, 2-methoxyethanol, 2-ethoxyethanol, and 2-butoxyethanol, acetonitrile, and 1,4-dioxane.

In the embodiment, in order to adjust the fluidity or chargeability of the toner particles, inorganic fine particles may be added and mixed in the surface of the toner particles in an amount of from 0.01 to 20% by weight based on the total weight of the toner. As such inorganic fine particles, silica, titania, alumina, strontium titanate, tin oxide, and the like can be used alone or in admixture of two or more kinds thereof.

It is preferred that as the inorganic fine particles, inorganic fine particles surface-treated with a hydrophobizing agent are used from the viewpoint of improvement of environmental stability. Further, other than such inorganic oxides, resin fine particles having a size of 1 μm or less may be externally added for improving the cleaning property.

Examples of a mixer for inorganic fine particles and the like include Henschel Mixer (manufactured by Mitsui Mining Co., Ltd.), Super Mixer (manufactured by Kawata Mfg. Co., Ltd.), Ribocone (manufactured by Okawara Mfg. Co., Ltd.), Nauta Mixer (manufactured by Hosokawa Micron, Co., Ltd.), Turbulizer (manufactured by Hosokawa Micron, Co., Ltd.), Cyclo Mixer (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the embodiment, further, coarse particles and the like may be sieved off. Examples of a sieving device which is used for sieving include Ultra Sonic (manufactured by Koei Sangyo Co., Ltd.), Gyro Shifter (manufactured by Tokuju Corporation), Vibrasonic System (manufactured by Dalton Co., Ltd.), Soniclean (manufactured by Shinto Kogyo K.K.), Turbo Screener (manufactured by Turbo Kogyo Co., Ltd.), Micro Shifter (manufactured by Makino Mfg. Co., Ltd.), and a circular vibrating sieve.

Hereinafter, the embodiment will be described in more detail by showing Examples and Comparative Examples.

### Example 1

70 Parts by weight of a high acid value polyester resin (manufactured by Kao Corporation, glass transition temperature: 60° C., acid value: 20) and 18 parts by weight of a low acid value polyester resin (manufactured by Kao Corporation, glass transition temperature: 60° C., acid value: 8) as binder resins, 5 parts by weight of cyan as a coloring agent, 6 parts by weight of an ester wax (carnauba wax, manufactured by Toa Kasei Co., Ltd.), and 1 part by weight of a charge control agent were mixed, and the resulting mixture was melt-kneaded using a twin-screw kneader which was set to a temperature of 120° C., whereby a kneaded material was obtained. The thus obtained kneaded material was coarsely ground to a volume average particle diameter of 1.2 mm using a hammer mill (manufactured by Nara Machinery Co., Ltd.), whereby coarse particles were obtained. 30 Parts by weight of the coarse particles, 2 parts by weight of an anionic surfactant (NEOPELEX G-65, manufactured by Kao Corporation), 3 parts by weight of an amine compound (dimethylamine, manufactured by Wako Pure Chemical Industries, Ltd.) and 133 parts by weight of ion exchanged water were placed in a high-pressure homogenizer manufactured by Beryu Co., Ltd., and a pulverization treatment was performed by the homogenizer under conditions of 180° C. and 150 MPa. The volume average particle diameter of resin fine particles obtained after cooling was measured using SALD-7000 (manufactured by Shimadzu Corporation) and found to be 0.78 μm.

120 Parts by weight of the thus obtained resin fine particle dispersion liquid and 80 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 5.60 μm. Further, the ratio of the standard deviation to the average particle diameter was 30.53%.

The toner particle dispersion liquid was heated to 200° C. on a hot plate to evaporate only an aqueous medium. Then, the solid content concentration in the dispersion liquid was determined from the difference in weight before and after heating and found to be 17.20%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 1.05 (femto C/10 μm).

### Example 2

166 Parts by weight of the resin fine particle dispersion liquid used in Example 1 and 33 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 5.86 μm. Further, the ratio of the standard deviation to the average particle diameter was 33.68%.

The toner particle dispersion liquid was heated to 200° C. on a hot plate to evaporate only an aqueous medium. Then, the solid content concentration in the dispersion liquid was determined from the difference in weight before and after heating and found to be 21.93%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 0.83 (femto C/10 μm).

### Example 3

70 Parts by weight of a high acid value polyester resin (manufactured by Kao Corporation, glass transition temperature: 60° C., acid value: 18) and 18 parts by weight of a low acid value polyester resin (manufactured by Kao Corporation, glass transition temperature: 64.9° C., acid value: 3) as binder resins, 5 parts by weight of cyan as a coloring agent, 6 parts by weight of an ester wax (carnauba wax, manufactured by Toa Kasei Co., Ltd.), and 1 part by weight of a charge control agent were mixed, and the resulting mixture was melt-kneaded using a twin-screw kneader which was set to a temperature of 120° C., whereby a kneaded material was obtained. The thus obtained kneaded material was coarsely ground to a volume average particle diameter of 0.91 mm using a hammer mill (manufactured by Nara Machinery Co., Ltd.), whereby coarse particles were obtained. 30 Parts by weight of the coarse particles, 2 parts by weight of an anionic surfactant (NEOPELEX G-65, manufactured by Kao Corporation), 3 parts by weight of an amine compound (dimethylamine, manufactured by Wako Pure Chemical Industries, Ltd.) and 133 parts by weight of ion exchanged water were placed in a high-pressure homogenizer manufactured by Beryu Co., Ltd., and a pulverization treatment was performed by the homogenizer under conditions of 180° C. and 150 MPa. The volume average particle diameter of resin fine particles obtained after cooling was measured using SALD-7000 (manufactured by Shimadzu Corporation) and found to be 0.91 μm.

84 Parts by weight of the thus obtained resin fine particle dispersion liquid and 385 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 6.75 μm. Further, the ratio of the standard deviation to the average particle diameter was 31.62%.

The toner particle dispersion liquid was heated to 200° C. on a hot plate to evaporate only an aqueous medium. Then, the solid content concentration in the dispersion liquid was determined from the difference in weight before and after heating and found to be 17.80%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 1.21 (femto C/10 μm).

### Example 4

150 Parts by weight of the resin fine particle dispersion liquid used in Example 3 and 50 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 5.60 μm. Further, the ratio of the standard deviation to the average particle diameter was 30.08%.

The toner particle dispersion liquid was heated to 200° C. on a hot plate to evaporate only an aqueous medium. Then, the solid content concentration in the dispersion liquid was determined from the difference in weight before and after heating and found to be 22.49%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 0.58 (femto C/10 μm).

### Comparative Example 1

78 Parts by weight of a high acid value polyester resin (manufactured by Kao Corporation, glass transition temperature: 60° C., acid value: 20) and 18 parts by weight of a low acid value polyester resin (manufactured by Kao Corporation, glass transition temperature: 60° C., acid value: 8) as binder resins, 5 parts by weight of cyan as a coloring agent, 6 parts by weight of an ester wax (carnauba wax, manufactured by Toa Kasei Co., Ltd.), and 1 part by weight of a charge control agent were mixed, and the resulting mixture was melt-kneaded using a twin-screw kneader which was set to a temperature of 120° C., whereby a kneaded material was obtained. The thus obtained kneaded material was coarsely ground to a volume average particle diameter of 1.2 mm using a hammer mill (manufactured by Nara Machinery Co., Ltd.), whereby coarse particles were obtained. 30 Parts by weight of the coarse particles, 2 parts by weight of an anionic surfactant (NEOPELEX G-65, manufactured by Kao Corporation), 3 parts by weight of an amine compound (dimethylamine, manufactured by Wako Pure Chemical Industries, Ltd.) and 133 parts by weight of ion exchanged water were placed in a high-pressure homogenizer manufactured by Beryu Co., Ltd., and a pulverization treatment was performed by the homogenizer under conditions of 180° C. and 150 MPa. The volume average particle diameter of resin fine particles obtained after cooling was measured using SALD-7000 (manufactured by Shimadzu Corporation) and found to be 0.93 μm.

84 Parts by weight of the thus obtained resin fine particle dispersion liquid and 385 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 11.2 μm. Further, the ratio of the standard deviation to the average particle diameter was 27.10%.

The toner particle dispersion liquid was heated to 200° C. on a hot plate to evaporate only an aqueous medium. Then, the solid content concentration in the dispersion liquid was determined from the difference in weight before and after heating and found to be 4.95%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 2.67 (femto C/10 μm).

### Comparative Example 2

108 Parts by weight of the resin fine particle dispersion liquid used in Comparative Example 1 and 295 parts by weight of ion exchanged water were mixed, and a hydrochloric acid was added thereto, and the temperature of the mixture was gradually raised to 92° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 11.61 μm. Further, the ratio of the standard deviation to the average particle diameter was 24.79%.

The toner particle dispersion liquid was heated to 200° C. on a hot plate to evaporate only an aqueous medium. Then, the solid content concentration in the dispersion liquid was determined from the difference in weight before and after heating and found to be 4.87%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 3.45 (femto C/10 μm).

### Comparative Example 3

88 Parts by weight of a high acid value polyester resin (manufactured by Kao Corporation, glass transition temperature: 59.8° C., acid value: 28.6) as a binder resin, 5 parts by weight of cyan as a coloring agent, 6 parts by weight of an ester wax (carnauba wax, manufactured by Toa Kasei Co., Ltd.), and 1 part by weight of a charge control agent were mixed, and the resulting mixture was melt-kneaded using a twin-screw kneader which was set to a temperature of 120° C., whereby a kneaded material was obtained. The thus obtained kneaded material was coarsely ground to a volume average particle diameter of 1.2 mm using a hammer mill (manufactured by Nara Machinery Co., Ltd.), whereby coarse particles were obtained. 30 Parts by weight of the coarse particles, 2 parts by weight of an anionic surfactant (NEOPELEX G-65, manufactured by Kao Corporation), 3 parts by weight of an amine compound (dimethylamine, manufactured by Wako Pure Chemical Industries, Ltd.) and 133 parts by weight of ion exchanged water were placed in a high-pressure homogenizer manufactured by Beryu Co., Ltd., and a pulverization treatment was performed by the homogenizer under conditions of 180° C. and 150 MPa. The volume average particle diameter of resin fine particles obtained after cooling was measured using SALD-7000 (manufactured by Shimadzu Corporation) and found to be 0.40 μm.

84 Parts by weight of the thus obtained resin fine particle dispersion liquid and 385 parts by weight of ion exchanged water were mixed, and hydrochloric acid was added thereto, and the temperature of the mixture was gradually raised to 91° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 21.02 μm. Further, the ratio of the standard deviation to the average particle diameter was 18.26%.

The toner particle dispersion liquid was heated to 200° C. on a hot plate to evaporate only an aqueous medium. Then, the solid content concentration in the dispersion liquid was determined from the difference in weight before and after heating and found to be 4.37%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 4.17 (femto C/10 μm).

### Comparative Example 4

( ) Parts by weight of the resin fine particle dispersion liquid used in Comparative Example 3 and ( ) parts by weight of ion exchanged water were mixed, and hydrochloric acid was added thereto, and the temperature of the mixture was gradually raised to 92° C. to aggregate the resin fine particles to a desired volume average particle diameter, whereby toner particles were obtained. The volume average particle diameter of the thus obtained toner particles was measured using a coulter counter (manufactured by Beckman Coulter, Inc.) and found to be 9.41 μm. Further, the ratio of the standard deviation to the average particle diameter was 16.54%.

The toner particle dispersion liquid was heated to 200° C. on a hot plate to evaporate only an aqueous medium. Then, the solid content concentration in the dispersion liquid was determined from the difference in weight before and after heating and found to be 5.87%.

The toner particles were washed by repeating a procedure including filtration of the toner particle dispersion liquid and washing with ion exchanged water until the electrical conductivity of the filtrate became 50 μS/cm. Thereafter, the toner particles were dried using a vacuum dryer until the water content became 1.0% by weight or less, whereby dried particles were obtained.

After drying, as additives, 2 parts by weight of hydrophobic silica and 0.5 parts by weight of titanium oxide were adhered to the surfaces of the toner particles, whereby an electrophotographic toner was obtained.

The thus obtained toner was mixed with a ferrite carrier coated with a silicone resin, and the resulting mixture was stirred for 30 minutes using a Turbula mixer (manufactured by Shinmaru Enterprises Corporation) in an environment of a temperature of 23.0° C. and a humidity of 53.0%, and then, left as such for 8.0 hours in an environment of a temperature of 30.0° C. and a humidity of 85.0%. The charge amount of the toner particles was measured using E-SPART (manufactured by Hosokawa Micron, Co., Ltd.) after stirring and after leaving as such, and the difference in charge amount was 3.45 (femto C/10 μm).

TABLE 1

| | Low acid value | High acid value | Diameter of resin | Solid content | Diameter of toner | | Change in |
|---|---|---|---|---|---|---|---|
| | polyester resin | polyester resin | fine particles | concentration | particles | CV value | charge amount |
| | (acid value) | (acid value) | (μm) | (wt %) | (μm) | (%) | (femto C/10 μm) |
| Example 1 | 8 | 20 | 0.78 | 17.2 | 5.6 | 30.53 | 1.05 |
| Example 2 | 8 | 20 | 0.78 | 21.93 | 5.86 | 33.68 | 0.83 |
| Example 3 | 3 | 20 | 0.91 | 17.8 | 6.75 | 31.62 | 1.21 |
| Example 4 | 3 | 20 | 0.91 | 22.49 | 5.6 | 30.08 | 0.58 |

TABLE 2

| | Low acid value | High acid value | Diameter of resin | Solid content | Diameter of toner | | Change in |
|---|---|---|---|---|---|---|---|
| | polyester resin | polyester resin | fine particles | concentration | particles | CV value | charge amount |
| | (acid value) | (acid value) | (μm) | (wt %) | (μm) | (%) | (femto C/10 μm) |
| Comparative | 8 | 20 | 0.93 | 4.95 | 11.2 | 27.1 | 2.67 |
| Example 1 | | | | | | | |
| Comparative | 8 | 20 | 0.93 | 4.87 | 11.61 | 24.79 | 3.45 |
| Example 2 | | | | | | | |
| Comparative | — | 28.6 | 0.4 | 4.37 | 21.02 | 18.26 | 4.17 |
| Example 3 | | | | | | | |
| Comparative | — | 28.6 | 0.4 | 5.87 | 9.41 | 16.54 | 3.45 |
| Example 4 | | | | | | | |

In a method for producing an electrophotographic toner including a pulverization step of pulverizing particles containing a polyester resin and a coloring agent to an average particle diameter of 1.0 μm or less by a mechanical shearing force in an aqueous medium and an aggregation step of aggregating the fine particles obtained by pulverization in the pulverization step, wherein the particles contains at least one or more kinds of low acid value binder resin having an acid value of from 1 to 13, the aggregated particles have an average particle diameter of from 1.0 μm to 10.0 μm and a ratio of the standard deviation to the average particle diameter of 30.0% or less, when the solid content concentration in the aggregated particle dispersion liquid in the aggregation step is set within a range from 5 wt % to 40 wt % which is higher as compared with a conventional method, the viscosity is increased and the shearing force applied to the respective aggregated particles is increased, and therefore, an aggregated particle dispersion liquid containing few coarse aggregated particles can be prepared. If the solid content concentration is lower than the above range, the shearing force applied to the aggregated particles is too small, and therefore, a problem arises that the particle diameter becomes larger than the desired toner particle diameter. Meanwhile, if the solid content concentration is higher than the above range, stirring becomes difficult due to an increase in the viscosity, and therefore, a shearing force is not applied to the aggregated particles, and thus, a problem arises that the particle diameter of the aggregated particles is increased, and so on.

Further, since the solid content concentration is increased as compared with a conventional method, the viscosity is increased, and negative effects such that the shearing force applied becomes uneven and the dispersion of an aggregating agent is inhibited are caused. However, the negative effects can be eliminated by using a high-speed homogenizer, adjusting the height of the stirring blade in a vessel or the like.

According to the production method of the embodiment, generation of coarse aggregated particles can be prevented, and therefore, an electrophotographic toner eventually having a uniform particle size distribution and also having good environmental performance against humidity can be obtained. Further, by adjusting the aggregated particle dispersion liquid so as to satisfy the following formula: 5≦A≦40 (wherein A represents a solid content concentration (wt %) in the aggregated particle dispersion liquid in the aggregation step), and making the solid content concentration in the dispersion liquid higher as compared with a conventional method, it is also possible to increase the productivity.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for producing a developing agent comprising:
mixing a granular mixture containing a binder resin having an acid value of from 1 to 13 and a coloring agent with an aqueous medium to form an aqueous dispersion liquid;
subjecting the formed dispersion liquid to mechanical shearing to pulverize the mixture in the dispersion liquid to forming fine particles having a volume average particle diameter smaller than that of the mixture; and
aggregating the fine particles in the dispersion liquid to form aggregated particles, followed by fusing the aggregated particles to form toner particles,
wherein the dispersion liquid containing the aggregated particles has a solid content concentration of from 5.0% to 40.0%, the aggregated particles have a volume average particle diameter of from 1.0 μm to 10.0 μm, and a ratio of the standard deviation to the volume average particle diameter of 30.0% or less.

2. The method according to claim 1, further comprising, after fusing the aggregated particles, adjusting the solid content concentration in the dispersion liquid to 5.0% to 40.0%.

3. The method according to claim 1, wherein the solid content concentration is from 10.0% to 35.0%.

4. The method according to claim 1, wherein the fine particles have a volume average particle diameter of 1.0 μm or less.

5. The method according to claim 1, wherein the binder resin is a polyester resin.

6. The method according to claim 1, wherein the granular mixture is obtained by melt-kneading the binder resin and the coloring agent, followed by grinding.

7. The method according to claim 1, wherein the aqueous dispersion liquid contains a surfactant and/or a pH adjusting agent.

8. The method according to claim 1, wherein the aqueous dispersion liquid has an alkaline pH.

9. The method according to claim 1, wherein the mechanical shearing is performed using a high-pressure homogenizer.

10. The method according to claim 1, wherein the mechanical shearing is performed using a mechanical shearing device having a pulverizing unit and a cooling unit which is arranged in tandem at a lower part of the pulverizing unit.

11. A developing agent comprising toner particles produced by a method including:
mixing a granular mixture containing a binder resin having an acid value of from 1 to 13 and a coloring agent with an aqueous medium, to forming an aqueous dispersion liquid;
subjecting the formed dispersion liquid to mechanical shearing to pulverize the mixture in the dispersion liquid to forming fine particles having a volume average particle diameter smaller than that of the mixture; and
aggregating the fine particles in the dispersion liquid to form aggregated particles, followed by fusing the aggregated particles to forming toner particles,
wherein the dispersion liquid containing the aggregated particles has a solid content concentration of from 5.0% to 40.0%, the aggregated particles have a volume average particle diameter of from 1.0 μm to 10.0 μm, and a ratio of the standard deviation to the volume average particle diameter of 30.0% or less.

12. The developing agent according to claim 11, wherein the method further includes, after fusing the aggregated particles, adjusting the solid content concentration in the dispersion liquid to 5.0% to 40.0%.

13. The developing agent according to claim 11, wherein the solid content concentration is from 10.0% to 35.0%.

14. The developing agent according to claim 11, wherein the fine particles have a volume average particle diameter of 1.0 μm or less.

15. The developing agent according to claim 11, wherein the binder resin is a polyester resin.

16. The developing agent according to claim 11, wherein the granular mixture is obtained by melt-kneading the binder resin and the coloring agent, followed by grinding.

17. The developing agent according to claim 11, wherein the aqueous dispersion liquid contains a surfactant and/or a pH adjusting agent.

18. The developing agent according to claim 11, wherein the aqueous dispersion liquid has an alkaline pH.

19. The developing agent according to claim 11, wherein the mechanical shearing is performed using a high-pressure homogenizer.

20. The developing agent according to claim 11, wherein the mechanical shearing is performed using a mechanical shearing device having a pulverizing unit and a cooling unit which is arranged in tandem at a lower part of the pulverizing unit.
